(19) United States
(12) Patent Application Publication
(10) Pub. No.: US 2011/0248815 A1
(43) Pub. Date: Oct. 13, 2011

(54) Method For Expanding The Adjustment Range of Overload Protection Devices, Associated Overload Protection Devices, and Their Use

(76) Inventors: Wolfgang Feil, Schwandorf (DE); Andreas Krätzschmar, Ammerthal (DE); Fritz Pohl, Hemhofen (DE)

(21) Appl. No.: 12/223,030

(22) PCT Filed: Jan. 23, 2007
(86) PCT No.: PCT/EP2007/000547

§ 371 Date: Jun. 27, 2011

(30) Foreign Application Priority Data
Jan. 23, 2006 (DE) 10 2006 003 124.5

(51) Int. Cl. H01H 61/013

(52) U.S. Cl. 337/94; 337/129

(57) ABSTRACT

In order to achieve thermomechanical overload protection with a broad adjustment range for protecting against overload currents, the live components carry an electrical current which is between the value of the overload current and zero. According to at least one embodiment of the invention, switching devices are used which, in a preferred embodiment, switch the current, in parallel, from a first current branch to at least one second current branch, the parallel-connected at least one current branch carrying a partial current, which is between the value of the overload current and zero. In the associated overload protection device, contact devices are provided which are associated with live components on two current branches which can be connected in parallel with one another, wherein at least one current branch can be switched on and off by the switching devices. In an alternative embodiment, a first and a second current branch are connected electrically in series by switching devices, as a result of which it is possible to switch over from an upper adjustment range to another, lower adjustment range of the broad adjustment range.

### PRIORITY STATEMENT

This application is the national phase under 35 U.S.C. §371 of PCT International Application No. PCT/EP2007/000547 which has an International filing date of Jan. 23, 2007, which designated the United States of America, and which claimed priority on DE 10 2006 003 124.5 filed Jan. 23, 2006, the entire contents of which is hereby incorporated herein by reference.

### FIELD

At least one embodiment the invention relates to a method for expanding the adjustment range of a thermomechanical overload protection device, in which a current set value can be predetermined by the user, and in which a defined tripping characteristic (current/time tripping curve) is intended to be achieved for the protection device. In addition, at least one embodiment of the invention also relates to associated thermomechanical overload protection devices, and to their use.

### BACKGROUND

The overload relays or overload releases are used in order to protect electrical installations and loads, for example motors, against unacceptably high operating currents. Non-electronic overload relays or overload releases contain thermal tripping members, for example bimetallic strips, snap-action disks or the like, and operate—in accordance with a current/time tripping characteristic—a mechanism which ensures that the relevant current branch is switched off when the operating currents are too high. This mechanism is, in particular, a latching mechanism unlocking device, a control switching contact or a signal alarm. The mechanism contains further elements in order to set the overload tripping to an operating current value within the current adjustment range. In order to eliminate the influence of the environmental temperature on the overload tripping, the mechanism in general also contains elements for temperature compensation.

U.S. Pat. No. 2,629,796 A discloses an adjusting device for a switching device, containing a U-shaped bimetallic strip with a parallel-connected shunt. The shunt connects the two limbs of the bimetallic strip at a different position, but which is permanently set by a welded joint. Current therefore flows only over the predetermined length element of the bimetal strip, and this is used to define the tripping current range. The dimensioning, that is to say the positioning of the tripping current range of the overload release, is defined as a function of the cross-sectional size of the heating resistance which is connected electrically in parallel with the bimetallic strip, and heats it. In this refinement of the overload release, its operating range may be placed within a current range from 10 to 200 A. Fixed adjustment ranges between 10 and 200 A can therefore easily be produced from the production engineering point of view.

Furthermore, DE 19 516 723 C2 discloses an adjustable thermomagnetic tripping device including a bimetallic strip and a first (bimetallic) shunt, in which these excite a hinged armature magnetic release, and a second shunt which is connected in parallel with the bimetallic strip and the first shunt. The second shunt is used to set the tripping value.

Finally, German Patent Specification No. 473 338 has already disclosed a magnetic/thermal overcurrent circuit breaker, in which contact means are provided, by means of which discrete values can be predetermined for the response sensitivity.

Known devices can be set to the desired operating current Iᵣ in a predetermined adjustment range, between a lower set current Iᵤ and an upper set current Iₒ, in order to match currently known overload protection devices to the respective regular operating current. The typical adjustment range, that is to say the so-called standard adjustment range, has until now covered only 1.4 to 1.6 times the lower set current Iᵤ. The equipment ranges of thermal overload relays and circuit breakers are designed with correspondingly narrow staggers in order, for example, to cover a current range from 1.8 A to 25 A with, for example, 12 adjustment range types.

In order to reduce the wide range of types, it is desirable to expand the current adjustment range of thermomechanical overload protection devices to at least Iₒ=2*Iᵤ. Simple, higher current loading of the thermal tripping member in order to expand the adjustment range does not work, however, because of the resistance heating, which is proportional to the square of the current, and the temperature increase associated with this.

FR 2 790 139 A1 discloses a switching device which has at least one contact device with which contact is selectively made before the switching device is brought into use. The adjustment range can therefore be predetermined in accordance with the requirements, although this range can no longer be varied during operation of the switching device. Further prior art is known from EP 0 923 101 A, FR 2 434 474 A1, DE 951 738 C, DE 21 01 456 A1, U.S. Pat. No. 4,187,482 A, DE 6607 433 U and FR 1 238 258 A. The aim in this case is essentially to match the sensitivity of the switching devices appropriately to the requirements.

In the prior art, the value adjustment range of overload protection devices is therefore normally provided by electronic overload relays or electronic overload releases. For this purpose, the overload current is detected by way of current transformers, and a tripping signal is generated by way of an electronically mapped current/time tripping characteristic. One advantage of this electronic solution is that the “heating”, that is to say the electrical power loss in the overload protection device, does not depend on its current set value, apart from the power loss, which is not linked with the operation of the device, on electrical line resistances in the protection device.

However, one disadvantage among others is the increased cost resulting from current transformers and electronics, as well as the unsuitability for monitoring of direct currents or direct-current components. Simple solutions are required for implement the wide adjustment range for overload protection devices, which can be produced at low cost in the range of relatively low rated currents (for example ≦40 A) and offer financial advantages to manufactures and users, in comparison to the wide range of modern types.

### SUMMARY

At least one embodiment of the invention is to specify a technical solution which allows the thermal tripping member to be operated in the specified operating range, with the current/time tripping characteristic of the standard adjustment range of previous thermal releases being maintained, although the predetermined current adjustment range is expanded in the desired manner, and to provide associated overload protection devices. In this case, any increase in the power loss is intended to be effectively limited or avoided in all operating modes of the overload protection device.

A further embodiment of the invention provides a defined current/time tripping characteristic for the release. A final aim of at least one embodiment is also to improve the matching of the response value of the short-circuit quick-action release as a function of the set values of the overload release described above.

At least one embodiment of the invention therefore allows specific adjustment ranges to be connected and disconnected by way of electrical resistances and/or defined heat flows, from the predetermined wide adjustment range, by the electrical contact means. If required, specific current set values can be fixed by additional adjustment device(s).

The method according to at least one embodiment of the invention preferably makes use of components of predetermined electrical resistance in order to carry current, and associated contact device(s). The contact device(s) may be designed such that they can either be mounted or can be switched. The use of the contact device(s) makes it possible to split the wide adjustment range into a first adjustment range, with lower and upper limit values, and into another, second adjustment range, with different lower and upper limit values.

In particular, for the purposes of the method according to at least one embodiment of the invention, it is possible to preselect two different adjustment ranges. These adjustment ranges may be separated by a gap, may overlap or else may advantageously be directly adjacent to one another, thus defining a so-called wide adjustment range.

At least one embodiment of the invention therefore allows the user of the switching device to preselect the suitable adjustment range in accordance with the respective requirement. The wide adjustment range which covers the operating current range of interest is therefore provided, so to speak virtually, using very simple technical device(s). In particular, this advantageously means that switchgear manufacturers and users have to store fewer different device types.

In order to provide the wide adjustment range for non-electronic overload protection devices, at least one embodiment of the invention makes use of thermal tripping members to which, according to at least one embodiment of the invention, current-carrying components can be connected. The switching operation may in this case be carried out in detail by mechanically operable switching contacts or by contact elements which can be mounted mechanically. The conceptual difference is the readiness for switching at any time by way of an operable switching contact, during the operation of the overload protection device and of the switching device being monitored by it, in comparison to the overload protection device and the switching device being monitored being positively taken out of use, with the contact element which can be mounted being remounted in order to select the adjustment range.

The advantages mentioned above can be achieved in two different ways (by two different principles). The two design forms have the common feature that the heating power for the bimetallic strip has the same value with respect to the same, relative operating current I_{r,rel} in all adjustment ranges of a wide adjustment range.

For this purpose, a parallel current path which contains at least one switching device is installed in parallel with the current path of the bimetallic strip, which may additionally contain a so-called heating conductor. When the switch in the parallel branch is closed, a defined proportion of the total current flows through the parallel branch, because of additional shunts and/or line resistances.

The opening/closing of the parallel branch results in two adjustment ranges between the lower set current Iᵤ₁ of the lower range and the upper set current Iₒ₂ of the upper range. When the switch is open, the (lower) range from Iᵤ₁ to Iₒ₁ remains unchanged, in which case Iₒ₁˜1.4 Iᵤ₁ to 1.6 Iᵤ₁. When the switch is closed, the upper range is preferably given by Iᵤ₂≈Iₒ₁ and Iₒ₂≈(1.4² to 1.6²)Iᵤ₁. This results in a linearly variable wide adjustment range from Iᵤ₁ to Iₒ₂ and an upper setting factor of 1.4² to 1.6²=1.96 to 2.56.

In a first height (resistance matching principle), the impedance of the parallel branch is matched such that it carries the relative current component (Iᵤ₂−Iᵤ₁)/Iᵤ₁ of the operating current Iᵣ when the upper adjustment range is selected. The bimetallic strip is heated only by the relative current component Iᵤ₁/Iᵤ₁. This unchanged heating of the bimetallic strip in the lower and in the upper adjustment range means that the tripping characteristic of the overload protection device remains unchanged. This will be explained further below with reference to FIG. 1.

For the purposes of at least one embodiment of the invention, the latter principle can be expanded, in particular for polyphase appliances, in that:
a) the current and adjustment ranges can be reset or set at any time and repeatedly, that is to say also during operation,
b) a plurality of parallel branches can be connected in steps by means of a changeover switch, thus increasing the adjustment range per step by a power (step 1: square of the lower adjustment range, step 2: third power of the lower adjustment range, etc.),
c) the temperature compensation is provided in the same way for all the phases at a central point,
d) a central mechanism exists, and operates the contact means for the parallel paths in all the phases at the same time,
e) the fundamental tripping mechanism (bimetallic strip, heated conductor, mechanical coupling of the bimetallic strip to the tripping member/latching mechanism), including protection against phase unbalance and phase failure, remains unchanged,
f) the parallel path, including the contact means and the current path resistances, can be plugged to the device in a modular form, without having to significantly modify the basic device.

This configuration can be used both for single-pole and for multipole overload protection devices. However, it must be remembered with this configuration that the current flow results in an additional power loss in the parallel current branch in the upper adjustment range. This power loss is kept away from the bimetallic strip by suitable thermal insulation.

In a second configuration (power matching principle), the disadvantage of an additional power loss is avoided. The power loss that results in the parallel branch is ideally all coupled to the bimetallic strip. For this purpose, the parallel branch has an impedance such that, when the parallel branch is switched on, the sum of the power losses through the bimetallic strip branch and the parallel branch in the upper adjustment range is equal to the power loss in the bimetallic strip branch when the parallel branch is open in the lower adjustment range.

In order to feed the power loss from the parallel branch into the bimetallic strip, the shunt in the parallel branch must be very closely physically connected to the bimetallic strip. For this purpose, the shunt is thermally connected to the bimetallic strip, either as a heating winding or in the form of indirect heating.

The abovementioned additional characteristics a) to e) are also retained in this configuration. All that is necessary is to modify the bimetallic strip with the shunt that is now additional.

In one variant of the second configuration, the current adjustment range which is preset as the wide adjustment range is not split by a parallel current branch that can be connected but by an additional heating conductor which can be electrically connected in series. The additional heating conductor is thermally coupled to the overload release such that its heating power is essentially all transferred to the thermomechanical actuator. When the additional heating conductor is connected in series, the lower range of the wide adjustment range is selected. The resistance of the additional heating conductor is of such a magnitude that the heating power of both heating conductors has the same value for an operating current in the lower adjustment range (index 1), as the heating power with the series current branch switched off and when the operating current in the upper adjustment range (index 2) is increased by the current factor (=Iᵤ₂/Iᵤ₁). The predetermined current adjustment range can be split into further adjustment ranges by means of further heating conductors which can be electrically connected in series. This results in a wide adjustment range which is expanded toward lower set currents. In the case of a single-stage, series circuit, the wide adjustment range typically covers set currents Iᵣ=Iᵤ up to Iᵤ*1.5² (=Iₒ), and Iᵣ=Iᵤ up to 1ᵤ^{*}1.5ⁿ⁺¹ (=Iₒ) for a series circuit with a plurality of stages (=n). If a fixed predetermined upper limit value is set for the set current for the wide adjustment range, then this results in the lower limit value for the n-stage series circuit Iᵤ=Iₒ/1.5ⁿ⁺¹ for the current factor 1.5.

A further measure within the scope of at least one embodiment of the invention is to provide a defined current/time tripping characteristic. This is thermally influenced by the thermal conductivity, in particular in the event of small overload currents, and by the heat capacity, in particular in the event of high overload currents, both of the active elements, that is to say of the current paths, of the bimetallic strip and in some cases of the heating conductors and of the contact element, as well as the passive components, such as attachments, housing, surrounding air.

For the purpose of at least one embodiment of the invention, this problem is solved as a function of the abovementioned configurations as follows: in the case of the resistance matching principle, that is to say without power losses from the parallel branch being injected into the bimetallic strip, the components of the parallel branch, that is to say the contact device(s) and shunts, are positioned in a thermally insulated form in separate areas of the device or in specific modules which can be plugged on. In the case of the power matching principle, that is to say with virtually all of the power loss from the parallel branch being injected into the bimetallic strip, there is a thermally close connection between the shunt in the parallel branch and the bimetallic strip. Since a short-circuit current load on the shunt is always less than that in the bimetallic strip branch when the parallel branch is switched off, in some circumstances plus an optionally included heating conductor, the shunt geometric dimensions can be designed to be correspondingly small, thus considerably reducing the heat capacity. In this case, it is advantageous to use materials which have a high electrical resistivity. Copper/nickel or chromium/aluminum alloys may be used for this purpose.

A further feature of this arrangement is for the resistance of the contact device(s) to be as low as possible. Large-area contacts with high contact forces are particularly suitable, for example plug-in contacts (banana plugs, lyre or blade contacts), and contacts with specific low-impedance contact materials, for example silver (Ag) alloys, for example silver nickel or fine-grain silver, or silver (Ag) composite materials, for example silver metal oxides.

Finally, the invention improves the matching of the response value of the short-circuit quick-action release as a function of the set value of the overload release described above.

In the case of circuit breakers, it is known for the short-circuit quick-action release to also be adjusted at the same time by adjustment of the overload release. This means that the short-circuit quick-action release becomes active at a specific, but defined, multiple of the variable operating current (response current).

Particularly in the case of motor circuit breakers, the response value of the short-circuit quick-action release is generally not adjusted, since these devices are, according to the prior art, operated only in a narrow current adjustment range. The response value is then a defined multiple (typically 8 to 15 times) the maximum set value Iₒ.

The introduction of a wide adjustment range with a considerably greater difference between Iᵤ and Iₒ results in the response time of the short-circuit quick-action release being spread to such a major extent that equipment is no longer adequately protected in the event of a short circuit and a low set current Iᵤ. Within the scope of at least one embodiment of the invention, this problem can be solved, for example, by partial tapping of the short-circuit quick-action release. In this case, the parallel branch which can be connected and has been described above is electrically connected to the coil of the short-circuit quick-action release such that the number of ampere turns per adjustment range, that is to say with or without the parallel branch connected, remains constant. This results in a multiple of the upper set value Iₒ which is in each case always the same, associated with the selected adjustment range for the response value of the short-circuit quick-action release.

The matching of the magnetic tripping can be carried out in four different ways according to at least one embodiment of the invention:

1. A parallel connection of a load-relief current branch can lead to the solenoid coil. In the case of a current factor of 1.5, the relative current component 0.5 is carried via the load-relief current branch, while the solenoid coil carries the relative current component 1.
2. The proportionality factor of the relationship magnetic force˜(current)*(current) can be matched. In the case of a solenoid coil, this can be done by tapping on the winding such that the total magnetic excitation of the winding corresponds to the relative current component 1 for the current factor of, for example, 1.5. In other words, the number of ampere turns when the tap for the relative current 1 is switched off is of equal magnitude to the number of ampere turns with the tap switched on, for the relative current 1.5. To this end, a predetermined portion of the winding can be bridged, and can thus be rendered magnetically effective. Instead of partial bridging, the winding can be tapped in order to derive a partial current such that the entire magnetic excitation of the winding once again corresponds to the relative current component 1 for the relative current 1.5.
3. Instead of being matched by the number of ampere turns, the proportionality factor can also be, matched by the air-gap width between the moving magnet armature and the opposing magnetic pole. This is likewise increased in relative units by the factor 1.5 in order to increase the response current from 1 to 1.5.
4. The restraining force of the magnet armature is adapted. The magnet armature must overcome the restraining force for a closing movement, and the tripping associated with this. The restraining force is generally produced by a spring element. The spring force is determined by the product of the spring constant and the spring movement. Increasing the spring movement by a factor of 1.5*1.5 compensates for the increase in the magnetic force for a current factor of 1.5.

The magnetic tripping is from the lower current adjustment range to the upper current adjustment range in the so-called wide adjustment range using the same contact device(s) as those for overload tripping. Additionally or alternatively, mechanical elements can be coupled to the contact device(s) in order to adjust the n-gap width of the spring movement.

### BRIEF DESCRIPTION OF THE DRAWINGS

Further details and advantages of the invention will become evident from the following description of the figures of example embodiments, with reference to the drawing and in conjunction with the pattern claims.

In detail, in each case illustrated schematically, in the figures:

FIG. 1 shows a design for an overload release with a parallel branch and thermal decoupling,

FIG. 2 shows a bimetallic release with a parallel current branch,

FIG. 3 shows an embodiment as shown in FIG. 1 for switching a plurality of adjustment, ranges in the wide adjustment range on and off,

FIG. 4 shows a design of an overcurrent release having a plurality of parallel branches and thermal coupling of the individual branches and partial tapping of a short-circuit quick-action release,

FIG. 5 shows a bimetallic branch with two heating windings,

FIG. 6 shows two heating windings, as shown in FIG. 5 connected in parallel, with a tripping coil having n turns,

FIG. 7 shows examples of thermal coupling of the bimetallic strip to the shunt of the parallel branch,

FIG. 8 shows further examples of thermal coupling as shown in FIG. 7, but with an additional heating conductor for the bimetallic-strip current path,

FIG. 9 shows a current/time characteristic for purely THERMAL TRIPPING (OVERLOAD RELEASE),

FIG. 10 shows a current/time characteristic for combined thermal/magnetic tripping (overload/short-circuit quick-action release),

FIG. 11 shows a three-pole switch using the means for provision of the wide adjustment range, avoiding thermal coupling of the parallel branch to the overload release,

FIG. 12 shows a three-pole switch using the means for providing the wide adjustment range with thermal coupling of the parallel branch to the overload release,

FIG. 13 shows a three-pole switch with means to provide the wide adjustment range as shown in FIG. 11 or FIG. 12, and with tapping which can be switched on for the release magnet coil.

### DETAILED DESCRIPTION OF THE EXAMPLE EMBODIMENTS

The implementation of the various variants of the wide adjustment range according to embodiments of the invention will be described in the following text, first of all using the example of an overload relay with a bimetallic strip and heating winding. The different configuration of the individual examples will in each case be described separately, with their function subsequently being described jointly:

In the individual figures, the reference symbols 1 denote a first current branch and 2 a second current branch, which is connected in parallel with the first current branch. Furthermore, the reference symbol 10 denotes a bimetallic strip which has a temperature-dependent switching function, as is known from the prior art as well.

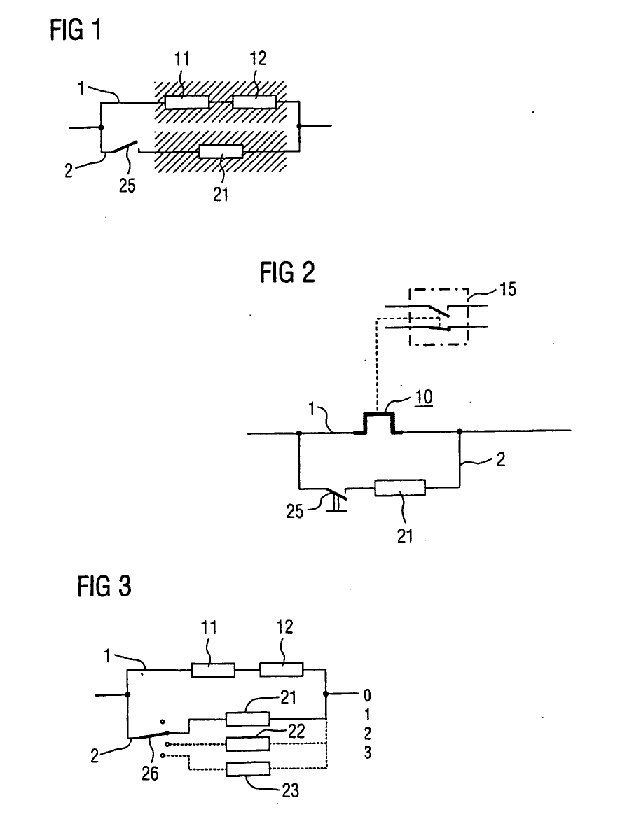

FIG. 1 illustrates the principle of resistance matching: the areas underneath show the thermal isolation between the bimetallic strip branch and the parallel branch: in detail, a bimetallic strip 11 with a heating conductor 12 is located in the area of the current branch 1, and a shunt 21 is located in the area of the current branch 2. The parallel branch 2 can be connected via a switch 25.

FIG. 2 shows a unit with control contacts 15, containing a make contact and a break contact. These are operated indirectly, mechanically, by way of a bimetallic release 10. Alternatively, the bimetallic release 10 can also operate a latching mechanism. Furthermore, as shown in FIG. 1, a switching contact 25 followed by a resistor 21, which corresponds to the shunt shown in FIG. 1, is arranged in the parallel current branch 2, corresponding to FIG. 1.

A dimension example for an embodiment as shown in FIG. 2 is as follows: the standard adjustment range of an overload relay is assumed to be between 11 and 16 A. The electrical resistance R_{bimetallic} of the bimetallic strip with a heating conductor is for this purpose approximately 8.6 mΩ. In order to expand the adjustment range from 16 A to 16/11*16 A=23 A, 7 A (=23 A−16 A) of the current is taken away from this by way of a parallel resistance that can be connected.

For this purpose, including the line and contact resistance, the parallel resistance has the following resistance value:

Rₚₐᵣₐₗₗₑₗ=R_{bimetallic}*11 A/5 A≈19 mΩ (1)

The parallel resistance is electrically connected to the electrical supplies to the connecting terminals for the bimetallic strip and the heating conductor, with the connecting lines being passed via a switching contact which can be operated mechanically. By way of example, this may be in the form of a banana plug contact whose plug can be inserted into the banana socket within a tubular guide against an opening spring, and whose switched-on and off positions can be fixed by means of suitable catches. The parallel resistance is preferably composed of resistance material with a low temperature coefficient and an adequately high application temperature.

A general dimensioning formula can be quoted from the standard adjustment range, with a lower set current iᵤ and an upper set current iₒ, for a single-step wide adjustment range without any gaps, and with an upper wide set current i_{o.w.} for the parallel resistance Rₚₐᵣₐₗₗₑₗ with respect to the bimetallic strip resistance R_{bimetallic}, as follows:

i_{o.w.}=i_{o.}²/iᵤ. (2)

with the current component of the parallel resistance being:

i_{o.w.,}iₚ=i_{o.w.}−i_{o.} (3)

and

Rₚₐᵣₐₗₗₑₗ=i_{o.}/(i_{o.w.}−iₒ.)*R_{bimetallic} (4)

an identical relationship is:

Rₚₐᵣₐₗₗₑₗ=i_{u.}/(i_{o.}−i_{u.})*R_{bimetallic}) (5)

In this context, R_{bimetallic} is the resistance of the bimetallic strip current branch between the connecting points of the parallel current branch.

The wide adjustment range for a three-pole overload relay is selected by means of a common, latching operating element which mechanically engages with the three switching contacts via a crossmember, and by which means the bimetallic strip current branches can be electrically connected in parallel with the parallel current branches associated with them. The parallel current branches with the associated switching contacts and parallel resistances may be arranged in a housing area of the overload relay separately from the bimetallic strips. This minimizes the mutual thermal influences and keeps the overload tripping characteristic unchanged.

On selection of the wide adjustment range, the tripping is shifted to higher currents and thus to a higher power loss in the overload relay. In comparison to the power loss in the standard adjustment range for i=i_{o.}=16 A and Pₑₗ=R_{bimetallic}*(16 A)², the power loss for the wide adjustment range for i=i_{o.w.}=23 A is:

Pₑₗ=R_{bimetallic}*(16 A)²+Rₚₐᵣₐₗₗₑₗ*(7 A)², (6)

which means a relative increase of 7/16, that is to say ≈40%.

In one advantageous refinement of the example shown in FIG. 2, which can offer both spatial advantages and a reduced power loss, the bimetallic strip current branch and the parallel current branch are accommodated in a common housing section. The parallel resistance may in this case be designed to have a lower resistance value than that mentioned above since the heating power, which has been reduced in this way, on the bimetallic strip can be compensated for by means of a certain amount of additional heating from the parallel resistance, that is to say by way of radiation and convection heat.

In one specific refinement, contacts may be provided with contact mounts which can be plugged in and/or rotated. As a secondary function of the plug-in contact mount, it interrupts the control contacts of the overload relay by way of suitable operating elements when in the uninstalled state. This ensures that the overload relay and the switching device being monitored by it are rendered inoperative until the plug-in contact mount is installed. An auxiliary tool, for example a screwdriver or the like, may be required to install the plug-in contact mount.

As a further variant, the three contact elements may be integrated in a common contact mount which can rotate. The rotational position of the contact mount may be latching, so that predetermined rotation angles are maintained, at which the wide adjustment range is reliably switched on or reliably switched off. In order to ensure this, the control contacts of the overload relay may be interrupted or not interrupted in predetermined rotation angle positions, so that the overload relay is ready to operate only when set correctly.

In general, contact elements which can be mounted mechanically allow higher contact forces to be achieved than operable switching contacts. This can advantageously be used to pass higher operating currents through the contact elements.

As a variant to the bimetallic strip current branch with the parallel current branch as shown in FIG. 2, the heating conductor may be partially bridged in order to produce the wide adjustment range. Contact elements which can be mounted, have relatively low contact resistances with relatively high contact forces and can carry the entire current for limited short-circuit currents are suitable for use as contacts for switching the wide adjustment range on and off. The contact resistance should be less than 1 mΩ in order that the majority of the current flows via the bridging current path, and only a small proportion flows via the bridged bimetallic strip section.

Roughly speaking, the residual heating power of the bridged section will compensate for the heat dissipation through the bridging conductor connected to the heating winding. In order to achieve the same bimetallic strip heating as in the example in FIG. 1, with the standard adjustment range and a current flow of 16 A has for the wide adjustment range and a current flow of 23 A, the remaining heating conductor must be bridged except for a relative proportion of (16/23)²≈0.5, which is not bridged.

A portion of the heating power from the heating conductor section which carries the full current is transferred by thermal conduction to the bridged subsection, so that it can be expected that the bimetallic strip will not be heated non-uniformly. Nevertheless, for example, bridging of the heating conductor in the bimetallic strip foot area has a greater effect on the deflection than at other points on the bimetallic strip, because of the interaction between the curvature and the lever arm. This can be compensated for in this example by bridging a shorter heating conductor section than (1−(16/23)²) in relative units.

In FIG. 3, three parallel-connected shunts 21, 22 and 23 are located in the area of the second current branch 2, with a correspondingly selective changeover switch 26 being provided for this purpose. The respective adjustment rates EB can be selected by connection of an appropriate shunt.

The following values result, for example, on the basis of the following tabular illustration:

TABLE 1
Adjustment range EB by shunt selection based on
the principle of resistance matching

| Step in FIG. 3 | Shunt | EB |
|---|---|---|
| 0 | ∞ | 1.00 → 1.40 |
| 1 | 250% | 1.40 → 1.96 |
| 2 | 104% | 1.96 → 2.74 |
| 3 | 57% | 2.74 → 3.84 |

The above principle of resistance matching with a plurality of parallel steps and examples of values for the resistance of the parallel branch therefore results in different adjustment ranges EB, which overall define the wide adjustment range WEB, such that WEB=(1.00 to 3.84)*Iᵤ.

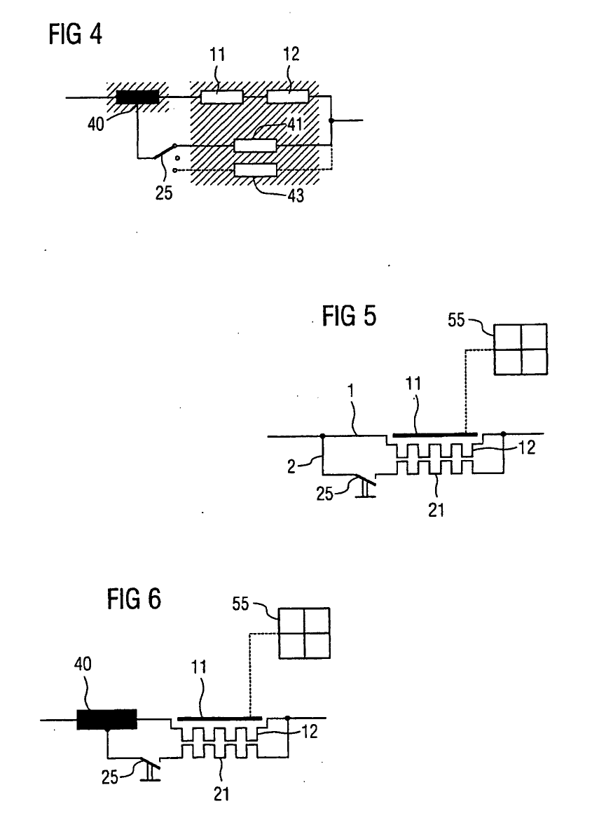

FIGS. 4 and 5 illustrate the principle of power matching: the common area illustrates the thermal coupling between the bimetallic strip branch and the parallel branch: FIG. 4 once again shows a bimetallic strip 11 and a heating conductor 12 in the main branch 1, as well as parallel-connected shunts and a heating conductor in the parallel branch 2. Furthermore, a tapping is provided on a coil 40, for a so-called n-release.

As already mentioned, these elements are thermally coupled, thus ensuring the required power matching by heat transfer.

As a dimension example for an embodiment based on the principle of power matching (FIGS. 4 to 6): the standard adjustment range of an overload relay is assumed to be between 11 and 16 A. This adjustment range will be referred to as the basic adjustment range GEB (in the example =16/11). Based on the principle of power matching, the thermal power loss in the bimetallic strip 11 must be constant in all adjustment ranges. For this purpose, the resistance of the parallel branch R_{PZ} must be designed to be as follows for a given resistance of the bimetallic strip branch R_{BZ}:

R_{PZ}=R_{BZ}/(GEB²−1) (7)

At an assumed (with a wide adjustment range) maximum operating current of Iᵣ=23.3 A, a current of I_{BZ}=Iₒ/GEB=11 A flows through the bimetallic strip current branch, and a current of I_{PZ}=I_{BZ}*R_{BZ}/(R_{BZ}+R_{PZ})=12.3 A flows through the parallel branch. This means that the current through the bimetallic strip branch is reduced by a factor 1/GEB. The thermal power loss reduced in this way in the bimetallic strip branch is compensated for completely by the thermal power loss in the parallel branch:

P_{v,bimetallic}=const.=I_{BZ}²*R_{BZ}+I_{PZ}²*R_{PZ} (8)

In this example, the operating current Iᵣ in the lower adjustment range (parallel branch open=inactive) can be set between Iᵤ=11 A and Iₒ=16 A, and in the upper adjustment range between Iᵤ*(16/11)=16 A and Iᵤ*(16/11)²=2.12*Iᵤ=23.3 A.

For multiple step adjustment ranges, the principle of power matching results, in comparison to the principle of resistance matching, in the following values (see Table 1 above):

TABLE 2
adjustment range EB by shunt selection based on
the principle of power matching

| Step in FIG. 3 | R_{PZ}/R_{BZ} | EB |
|---|---|---|
| 0 | ∞ | 1.00 → 1.40 |
| 1 | 104% | 1.40 → 1.96 |
| 2 | 35% | 1.96 → 2.74 |
| 3 | 15% | 2.74 → 3.84 |

In FIG. 5, two heating conductors are associated in parallel with the bimetallic strip, with the short-circuit quick-action release from FIG. 4 also being provided in FIG. 6.

FIG. 4 shows the principle of power matching: the common area denotes the thermal coupling between the bimetallic strip branch and the parallel branch. In FIG. 4, a bimetallic strip 11 and a heating conductor 12 are once again provided in the main branch 1, as well as parallel-connected shunts and heating conductors in the secondary branch 2. Furthermore, a coil 40 is tapped for a so-called n-release.

As already mentioned, these elements are thermally coupled, so that the required power matching is ensured by heat transfer.

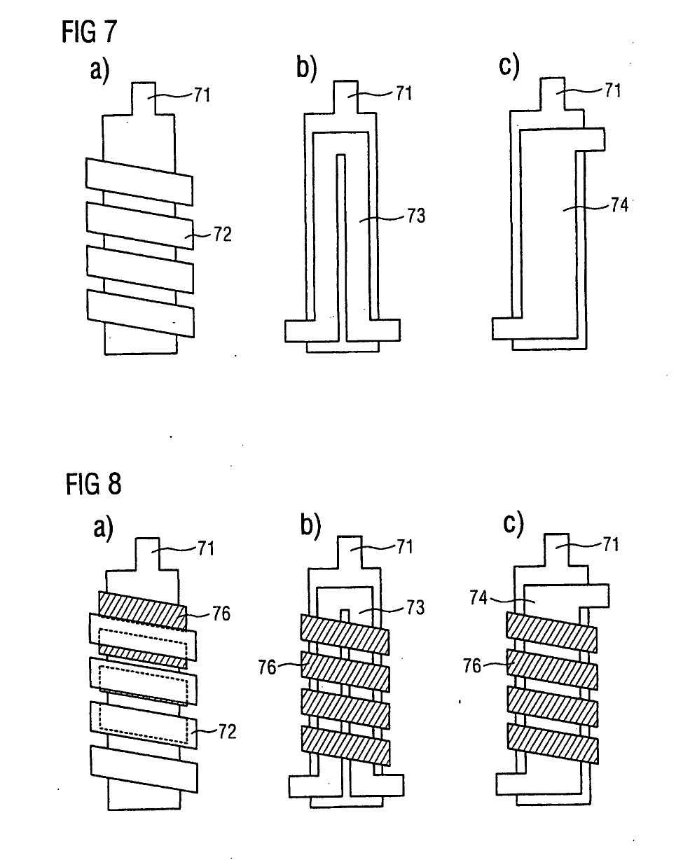

An alternative to matching of the bimetallic strip heating to the wide adjustment range is, with the heating conductor still having virtually the same length, to enlarge its cross-sectional area, and thus to reduce the resistance. This can be achieved, for example, as shown in FIG. 7, by connecting a second heating conductor 72 in parallel with the heating conductor 71 for the standard adjustment range, producing this effective increase in cross-sectional area. It is advantageous that the switching contact that is required for this purpose, as in the example in FIG. 1, need carry only part of the current, both in rated operation and in the event of a short circuit. The disadvantages are the increased stiffness of the bimetallic strip heater and the different thermal coupling between the individual heating conductors and the bimetallic strip, since the heating conductors must be electrically isolated from one another, except for the joint connection. This shifts the tripping time characteristic in the direction of longer tripping and resetting times.

In FIG. 5, two heating conductors are associated in parallel with the bimetallic strip, with the n-release from FIG. 4 also being provided in FIG. 6.

FIGS. 7a, 7b and 7c show alternatives for thermal coupling of a winding 72 or shunts 73 or 74 in the parallel branch to a bimetallic strip 71 without the original heating winding for the bimetallic strip in the overload protection device 10 from FIG. 2: this results in good thermal coupling. The bimetallic strip 71 and the shunts 72, 73 and 73 are, for example, electrically isolated from one another by glass fiber or Mica.

FIGS. 8a, 8b and 8c show alternatives for thermal coupling of the winding 72 or of the shunt 72 or shunt 73 in the parallel branch to the bimetallic strip with the original heating winding 76 for the bimetallic strip 71; this likewise results in good thermal coupling. The heating conductor 76 is electrically isolated from the other current path components by glass fiber or Mica.

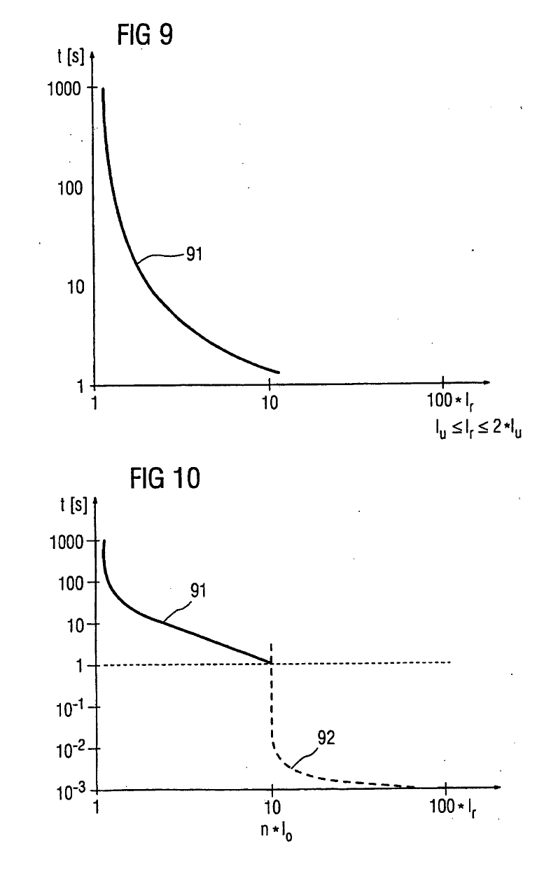

Using a log/log representation, FIGS. 9 and 10 both show the tripping time of the overload release as a function of the multiple of the set current Iᵣ: the multiple of the current Iᵣ at which tripping takes place is plotted on the abscissa, and the tripping time t is plotted on the ordinate. In this context, FIG. 9 shows the graph 91 as the tripping characteristic, and FIG. 10 shows the graphs 91 and 92.

For a wide adjustment range of the set current Iᵣ, for which Iᵤ<=Iᵣ<=2*Iᵤ, the lower adjustment range and the upper adjustment range result in largely the same tripping characteristic. In addition to the overload tripping characteristic 91, FIG. 10 also shows the short-circuit tripping characteristic 92. The short-circuit tripping characteristic 92 is in general quoted as a multiple of the upper limit value of the chosen range. A short-circuit tripping characteristic 92 which remains the same for the lower and the upper adjustment range can be achieved by switching the partial tap of the short-circuit quick-action release on and off.

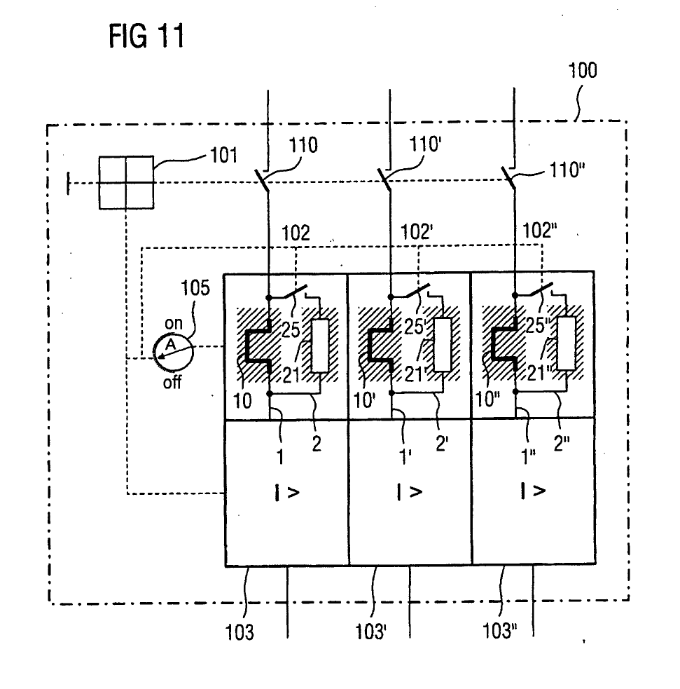

FIG. 11 shows a three-pole switch 100 with a latching mechanism 101, three switch contacts 110, 110′, 110″ and associated overload releases. Electrothermal overload releases 102, 102′, 102″ on the one hand and electromagnetic short-circuit releases 103, 103′, 103″ on the other hand can be seen in each case. In this case, the electrothermal releases 102, 102′, 102″ contain bimetallic strips in the current branch and parallel current branches, which can be connected, with resistances and switches as shown in FIG. 1, or one of the further different examples in FIGS. 2 to 10. Specially, the parallel current branches can be switched on and off manually by a mechanical operating means 105 with an associated “on/off” indication, thus providing the wide adjustment range, as has been described in detail above. Automated setting of the respective range is also possible.

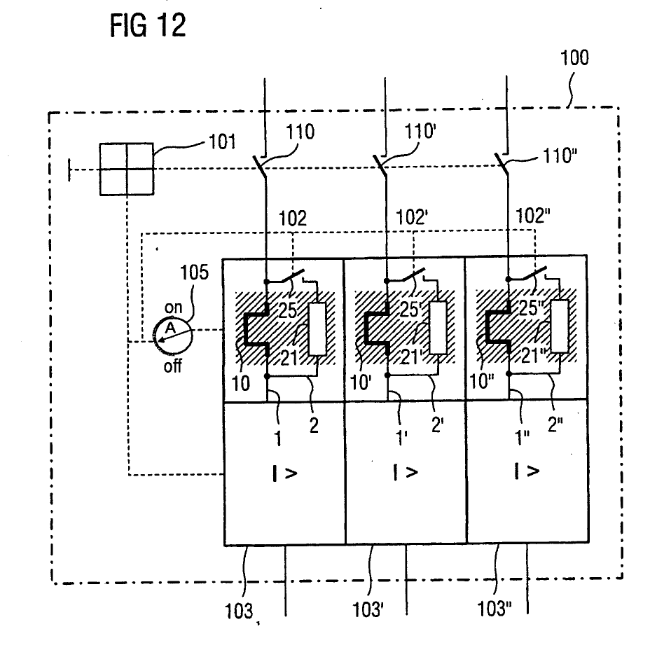

FIG. 12 illustrates how power matching can be achieved, rather than resistance matching, by thermal coupling, as is indicated by the common arrangement of the components. Suitable devices/methods are used for this purpose, as described above with reference to FIGS. 4 to 8.

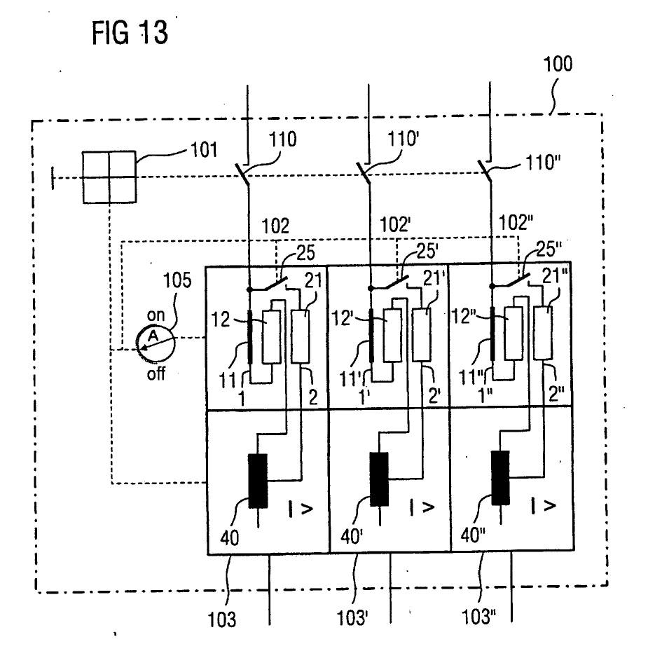

The latter is illustrated in more detail in FIG. 13. In this case, the bimetallic strip 11 with the heating element in each case has a further directly associated heating winding 21, thus producing a thermally coupled unit. Furthermore, the magnet coil 40 of the short-circuit quick-action release is tapped by the parallel-connected heating conductor 21.

The invention has been described in particular for overload relays. In other preferred applications, the devices described above are used for wide range adjustment for motor circuit breakers or else for a circuit breaker.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for expanding the adjustment range of overload protection devices, in which a predetermined current adjustment range is provided, having means for setting the overload protection to an operating current within the current adjustment range, with components of predetermined electrical resistance being used to carry current and associated contact means, having the following measures in order to achieve a wide adjustment range:
the predetermined current adjustment range is split into adjustment ranges,
one specific adjustment range is chosen by use of the contact means, and
the selected adjustment range is limited by a lower and an upper current setting value.

2. The method as claimed in claim 1, characterized in that the predetermined current adjustment range is split into a first and a second adjustment range.

3. The method as claimed in claim 2, characterized in that a predeterminable gap is chosen between a first and a second adjustment range.

4. The method as claimed in claim 2, characterized in that a first and a second adjustment range are chosen such that they overlap.

5. The method as claimed in claim 2, characterized in that a first and a second adjustment range are chosen such that they are adjacent to one another.

6. The method as claimed in one of claims 2 to 5, characterized in that the two adjustment ranges form a continuous wide adjustment range.

7. The method as claimed in one of claims 2 to 6, characterized
in that the contact means are mounted in order to switch from the first to the second adjustment range.

8. The method as claimed in one of claims 2 to 6, characterized in that the contact means are switched in order to switch from the first to the second adjustment range.

9. The method as claimed in claim 1 for use in a multipole switching device, characterized in that the adjustment ranges are preselected manually on the switching device.

10. The method as claimed in claim 1 for use in a multipole switching device, characterized in that the adjustment ranges are set automatically on the switching device.

11. The method as claimed in claim 5, characterized in that a thermal release and a tripping member, which can be set to an operating current within the wide adjustment range and trips in accordance with a current/time characteristic in the event of an overload current, are used in order to set the wide adjustment range.

12. The method as claimed in one of the preceding claims, having the following features:
the components for carrying current carry an electric current which is between the value of the overload current and zero or is equal to one of these two values,
the components for carrying current contain at least one first and one second current branch,
the contact means connect the at least one first current branch electrically in parallel with a second current branch,
the parallel-connected, at least one current branch carries an electric current element which is between the value of the overload current and zero,
by presetting the resistance values in the at least two current branches, the current element in the parallel-connected at least one current branch is set to a preferred proportion of the operating current,
the different-magnitude operating currents, which are associated with the switched-on state and the switched-off state of the at least one current branch in the thermomechanical overload protection device are of such a magnitude that the associated operating currents produce approximately the same heating power at the thermal release,
the adjustment range is switched from a lower current range to a higher current range, which is adjacent to the former without any gap, by switching on the at least one current branch, thus creating a wide adjustment range, and
the wide adjustment range can be expanded by having further current ranges, in the direction of higher currents, added to it by switching on a further or a plurality of parallel-current branches.

13. The method as claimed in one of claims 1 to 11, having the following features:
the components for carrying current carry an electric current which is equal to the value of the overload current, or is equal to zero,
the components for carrying current contain at least one first and one second current branch,
at least one of the at least two current branches carries the overload current,
the contact means connect the at least one first current branch electrically in series with a second current branch,
the series-connected, at least one current branch likewise carries the overload current,
the heating power of the current branches which carry the overload current is all injected into the thermal release,
the heating power at the thermal release is set by presetting the resistance values in the at least two current branches which can be connected in series,
the different-magnitude operating currents, which are associated with the switched-on state and switched-off state of the at least one current branch, of the thermomechanical overload protection devices are of such a magnitude that the associated
operating currents produce approximately the same heating power at the thermal release,
the adjustment range is switched from a higher current range to a lower current range, which is adjacent to the former without any gap, by switching on the at least one current branch, thus creating a wide adjustment range, and
the wide adjustment range can be expanded by having further current ranges, in the direction of lower currents, added to it by switching on a further or a plurality of parallel-current branches.

14. The method as claimed in claim 11, characterized in that, by switching a single parallel current branch on and off, the wide adjustment range extends from a lower current limit Iᵤ when the parallel current branch is switched off to an upper current limit Iₒ when the parallel current branch is switched on, with the upper current limit being between 1.3 times and 3 times the lower current limit.

15. The method as claimed in claim 11, characterized in that an enlarged wide adjustment range is obtained by switching two parallel current branches on and off, the upper current limit of which wide adjustment range is between 1.8 times and 5 times the lower current limit.

16. The method as claimed in claim 11, characterized in that the thermal release is heating by the heating effect of at least a portion of the electric current flowing in the overload protection device.

17. A thermomechanical overload protection device, in particular for carrying out the method as claimed in claim 1 or one of claims 2 to 16, in order to provide a wide adjustment range for protection against overload currents, containing current-carrying components, a thermal release and a tripping member, which can be set within the wide adjustment range to an operating current, and trips in accordance with
a predetermined current/time characteristic in the event of an overload current, having the following features,
the current-carrying components contain switching means (12), electrical resistance materials (10) and electrical conductors (1, 2),
the current-carrying components are distributed between at least two current branches (1, 2)
at least one current branch (1) of the at least two current branches (1, 2) can be switched on and off by the switching means (12), and
the switching means (12) connect the at least one current branch (1) electrically in parallel with the second current branch (2).

18. The overload protection device as claimed in claim 17, characterized in that the wide adjustment range is created by parallel connection of a resistor (21, 22, 23) without thermal injection of the electrical power from the resistor (21, 22, 23) into the thermal release. (Resistance matching).

19. The overload protection device as claimed in claim 17, characterized by a single-phase configuration.

20. The overload protection device as claimed in claim 17, characterized by a three-phase configuration.

21. The overload protection device as claimed in claim 16, characterized by a modular configuration.

22. The overload protection device as claimed in claim 17, characterized in that the wide adjustment range is created by parallel connection of a resistor (41, 42) with thermal injection of the electrical power from the resistor (41, 42) into the thermal release. (power latching).

23. The overload protection device as claimed in claim 22, characterized in that, low-impedance contact means are chosen for a single-phase configuration
in particular for thermal coupling of a shunt (41, 42) in the parallel branch (2) to a bimetallic strip (10).

24. The overload protection device as claimed in claim 23, characterized by an expansion capability to three-phase requirements.

25. The overload protection device as claimed in claim 17, characterized by partial tapping of a magnetic short-circuit quick-action release (40) in conjunction with the wide adjustment range.

26. The overload protection device as claimed in claim 25, characterized by a constant number of ampere turns per range.

27. The overload protection device as claimed in claim 17, characterized in that a thermal release is provided, with a bimetallic release (10) without a heating winding.

28. The overload protection device as claimed in claim 27, characterized in that the thermal release contains a bimetallic release (10) and at least one thermally coupled heating winding (12, 21).

29. The overload protection device as claimed in one of claims 17 to 28, characterized in that the current branch which can be connected is a parallel current branch (2) with an electrical resistor (41, 43).

30. The overload protection device as claimed in claim 29, characterized in that the current branch (1) with the bimetallic strip (10) and the parallel current branch (2), are accommodated in a common housing section.

31. The overload protection device as claimed in claim 29, characterized in that the current branch (1) with the bimetallic strip (10), and the parallel current branch (2), are accommodated in mutually separate housing sections.

32. The overload protection device as claimed in claim 31, characterized in that the parallel current branch (2) with a separate housing can be connected to the tripping device, with the parallel current branch being connected electrically in parallel with the bimetallic strip current branch (1, 10).

33. The overload protection device as claimed in one of claims 17 to 32, characterized in that the switching means (12) are in the form of mechanically operable contact elements.

34. The overload protection device as claimed in one of claims 17 to 33, characterized in that the switching means are in the form of contact elements which can be mounted mechanically.

35. The overload protection device as claimed in one of claims 17 to 34, characterized in that means (12) are provided for partial bridging of the bimetallic heating winding (10).

36. The overload protection device as claimed in one of claims 17 to 35, characterized in that a plurality of heating windings (41, 42) can be connected electrically in parallel with one another by switching means (63).

37. The overload protection device as claimed in claim 36, characterized in that the volume of each heating winding is matched to the current heat absorbed by it in the event of a short circuit.

38. The overload protection device as claimed in claim 37, characterized in that the maximum permissible temperature can be reached by each heating winding (41, 42) in the event of a short circuit.

39. The overload protection device as claimed in one of claims 36 to 38, characterized in that, when there are two heating windings, the second heating winding has approximately 25% of the heat capacity of the first heating winding.

40. The overload protection device as claimed in one of claims 36 to 38, characterized in that, when there are three heating windings, the third heating winding has approximately 11% of the heat capacity of the first heating winding.

41. The overload protection device as claimed in one of claims 17 to 40, characterized in that a single-pole thermomechanical tripping device (102) is included, and operates a tripping member in order to trip a single-pole switching mechanism (110).

42. The overload protection device as claimed in one of claims 17 to 40, characterized in that a multipole thermomechanical tripping device (102, 102′, 102″) is included and operates a tripping member in order to trip a multipole switching mechanism (110, 110′, 110″).

43. The overload protection device as claimed in one of claims 17 to 42, characterized in that the switching mechanism includes a latching mechanism (101).

44. The overload protection device as claimed in one of claims 17 to 43, characterized in that the switching mechanism includes a magnetic drive.

45. The overload protection device as claimed in one of claims 17 to 43, characterized in that the switching mechanism includes a magnetic drive and a latching mechanism (101).

46. The overload protection device as claimed in one of claims 17 to 45, characterized in that a display means (105) is provided in order to display the selected operating current.

47. The overload protection device as claimed in claim 46, characterized in that the set current value can be adjusted and/or read by an information bus.

48. The overload protection device as claimed in claim 47, characterized
in that the information bus detects the overload tripping, and in that switching devices in the circuit in which the tripping device (102) has tripped are switched off via the information bus.

49. The overload protection device as claimed in one of claims 17 to 48, characterized in that the tripping device (102) is installed in the housing (100) of a switching device.

50. The overload protection device as claimed in one of claims 17 to 48, characterized by its own appliance housing.

51. The use of an overload protection device as claimed in one of claims 17 to 50 for overload relays.

52. The use of an overload protection device as claimed in one of claims 17 to 50 for a motor circuit breaker.

53. The use of an overload protection device as claimed in one of claims 17 to 50 for a circuit breaker.
